(19) United States
(12) Patent Application Publication
(10) Pub. No.: US 2017/0184748 A1
(43) Pub. Date: Jun. 29, 2017

(54) A METHOD AND A COMPUTING SYSTEM FOR SEISMIC IMAGING A GEOLOGICAL FORMATION

(71) Applicant: SCHLUMBERGER TECHNOLOGY CORPORATION, Sugar Land, TX (US)

(72) Inventors: Vasily Grigoryevich BAYDIN, Chelyabinsk (RU); Leonid Evgenyevich DOVGILOVICH, Moscow (RU); Ivan Lvovich SOFRONOV, Moscow (RU)

(21) Appl. No.: 15/312,863

(22) PCT Filed: May 21, 2014
(86) PCT No.: PCT/RU2014/000363

§ 371 Date: Nov. 21, 2016

(51) Int. Cl. G01V 1/36

(52) U.S. Cl. CPC G01V 1/36; G01V 2210/161; G01V 2210/51

(57) ABSTRACT

Data of vertical seismic profile in the geological formation are recorded and at least one estimation of a geological formation local model dip is performed, also at least one dynamic dip estimation is performed for at least one wavetype excited by sources and registered by receivers using directionally-based vectors. A difference between the local model dip estimation and the dynamic dip estimation is calculated. Based on the calculated difference between the local model dip estimation and the dynamic dip estimation at least one weighting coefficient is calculated. The calculated at least one weighting coefficient is used for determining at least one formulae for imaging with the use of elastic waves at reverse time migration conditions taking into account a dip angle of the geological formation. The determined at least one formulae is applied to the obtained vertical seismic profile data and at least one image of the geological formation is produced.

### CROSS-REFERENCE TO RELATED APPLICATION

This application is a U. S. National Stage Application under 35 U.S.C. §371 and claims priority to Patent Cooperation Treaty Application Number PCT/RU2014/000363 filed May 21, 2014, which is incorporated herein by reference in its entirety.

### TECHNICAL FIELD

The present disclosure relates generally to seismic exploration, and more particularly relates to a method and system for imaging a subsurface geological formation.

### BACKGROUND

Seismic imaging is a numerical method of creating seismic images of a geological formation based on data recorded by sesmic receivers located at the surface on in a well. This process allows to identify and characterize hydrocarbon reservoirs.

High-resolution seismic images of a subterranean formation are essential for quantitative seismic interpretation and improved reservoir monitoring. In situations involving complex structures and steeply dipping reflectors often found in complicated subsurface geological formations such as those in and below salt flanks, current ray-based migration methods have significant limitations due to waveform multi-pathing, including caustic and prismatic waves.

Reverse time migration (RTM), however, can better handle those complicated wavepaths by correlating wave fields that are properly propagated forward in time from sources and backward in time for receivers ((see, for example, Chang and McMechan, Elastic Reverse Time Migration, Geophysics, 1987, vol. 52, No. 10, p.p. 1365-1375). Two drawbacks of RTM when applied to a surface seismic profile (SSP) are: (1) imaging artifacts from backscattering; and (2) unbalanced amplitudes. Those undesirable effects can be removed or reduced by applying: (1) a Laplacian filter; (2) a more appropriate formula to construct the image; and (3) an obliquity compensation factor.

It is known a method for seismic imaging wherein a dip-filter was introduced for acoustic RTM (US2013182538). But in elastic RTM the problem of artifacts is more pronounced as compared to acoustic RTM because of pressure/shear waves interaction. Generalization of this known method for the elastic RTM requires new elements due to the multi-component nature of the elastic wavefield. The wavefield is a mixture of pressure and shear waves. Therefore the algorithm of the wave direction estimation must correctly determine directions of both wave types. Elastic RTM method generates at least four images classified with respect to reflection types (PP, PS, SP, SS). The dip estimation technique must be different for converted wave events.

### SUMMARY

The disclosed method is aimed to reduce or eliminate artifacts such as false structural artifacts and swing artifacts in images obtained with the use of elastic waves by reverse time migration method RTM based on multicomponent data of vertical seismic profiling (VSP).

The method for seismic imaging a geological formation comprises recording data of vertical seismic profile in the geological formation, performing at least one estimation of a geological formation local model dip and performing at least one dynamic dip estimation for at least one wavetype excited by sources and registered by receivers using directionally-based vectors. Then a difference between the local model dip estimation and the dynamic dip estimation is calculated. Based on the calculated difference between the local model dip estimation and the dynamic dip estimation at least one weighting coefficient is calculated. The calculated at least one weighting coefficient is used for determining at least one formulae for imaging with the use of elastic waves at reverse time migration conditions taking into account a dip angle of the geological formation. The determined at least one formulae is applied to the obtained vertical seismic profile data and at least one image of the geological formation is produced.

In accordance with some embodiments, a computing system is provided, the system comprises at least one processor, at least one memory, and at least one program stored in the at least one memory. The programs are configured to be executed by the processors and include instructions for: recording data of vertical seismic profile in the geological formation, performing at least one estimation of a geological formation local model dip, performing at least one dynamic dip estimation for at least one wavetype excited by sources and registered by receivers using directionally-based vectors, calculating a difference between the local model dip estimation and the dynamic dip estimation, calculating at least one weighting coefficient based on the calculated difference between the local model dip estimation and the dynamic dip estimation, using the calculated at least one weighting coefficient for determining at least one formulae for imaging with the use of elastic waves at reverse time migration conditions taking into account a dip angle of the geological formation and applying the determined at least one formulae to the obtained vertical seismic profile data and producing at least one image of the geological formation.

In some embodiments, the at least one estimation of the geological formation model local dip is performed using surface seismic profile data.

In some embodiments, the directionally-based vectors are selected from the group consisting of phase velocity vectors, group velocity vectors, optical flow vectors, and energy flux (Poynting) vectors.

In some embodiments, the wavetypes excited by the sources and registered by the receivers comprise pressure and shear waves. The at least one dynamic dip estimation for pressure and shear waves reflected with conversion is determined using the Snell's law.

In some embodiments, the weighting coefficient is inversely proportional to the value of the difference between the model local dip estimation and the dynamic dip estimation.

In some embodiments, wherein the directionally-based vectors are spatially smoothed.

### BRIEF DESCRIPTION OF DRAWINGS

Some embodiments of the disclosure are illustrated by the drawings described below.

FIG. 1A shows a downhole surveying system of a vertical seismic profile (VSP) having a particular survey geometry.

FIG. 1B illustrates a fragment of pressure waves (PP) with elastic waves migration by RTM method according to the surveying system shown on FIG. 1A.

FIG. 1C illustrates a fragment of shear waves (PS) with elastic waves migration by RTM method according to the surveying system shown on FIG. 1A.

FIG. 2 illustrates an example computing system for one or more disclosed embodiments in accordance with the present disclosure.

FIG. 3 schematically demonstrates directions of the waves and geometric considerations in RTM for VSP in accordance with the present disclosure.

FIG. 4A schematically shows angles α, β, γ and vector c in accordance with the present disclosure.

FIG. 4B schematically shows angles γ, γ₀ and δ in accordance with the present disclosure.

FIG. 5A shows the resulting image of pressure waves (PP) with elastic waves migration by RTM method taking into account a dip of the geological formation in accordance with the present disclosure.

FIG. 5B shows the resulting image of shear waves (PS) with elastic waves migration by RTM method taking into account a dip of the geological formation in accordance with the present disclosure.

FIG. 6A shows an approximate model with the downhole surveying system VSP in accordance with the present disclosure.

FIG. 6B shows a model dip based on the approximate model in accordance with the present disclosure.

FIG. 7 shows a flowchart with possible steps for one or more embodiments in accordance with the present disclosure.

### DETAILED DESCRIPTION

Some embodiments will now be described with reference to the figures. In the following description, numerous details are set forth to provide an understanding of various embodiments and/or features. However, it will be understood by those skilled in the art that some embodiments may be practiced without many of these details and that numerous variations or modifications from the described embodiments are possible.

The terminology used in the description of the invention herein is for the purpose of describing particular embodiments only and is not intended to be limiting of the invention. As used in the description of the invention and the appended claims, the singular forms are intended to include the plural forms as well, unless the context clearly indicates otherwise.

A system and method to perform multicomponent elastic reverse time migration model dip-guided imaging are disclosed. While this disclosure involves the procedure to accomplish elastic reverse time migration model dip-guided imaging using vertical seismic profile (VSP) data, those of ordinary skill in the art will recognize that the various disclosed embodiments may be applied in many contexts for many types of collected data to image features in a subsurface region. The disclosed system and method may be used in conjunction with a computing system as described below.

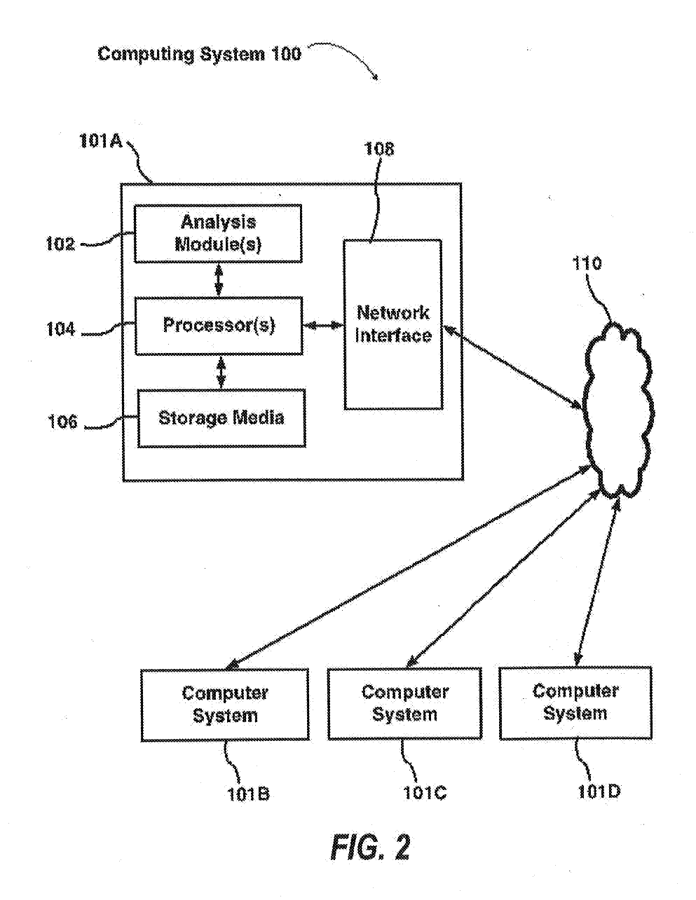

A computing system 100 shown in FIG. 2 can be an individual computer system 101A or an arrangement of distributed computer systems. The computer system 101A comprises one or more analysis modules 102 that are configured to perform various tasks according to some embodiments, such as one or more methods disclosed herein (e.g., any of the steps, methods, techniques, and/or processes, and/or combinations and/or variations and/or equivalents thereof). To perform those various tasks, analysis module 102 operates independently or in coordination with one or more processors 104 that is (or are) connected to one or more storage media (memory) 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C, and/or 101D may or may not share the same architecture as computer system 101A, and may be located in different physical locations, e.g. computer systems 101A and 101B may be on a ship underway on the ocean, while in communication with one or more computer systems such as 101C and/or 101D that are located in one or more data centers onshore, on other ships, and/or located in various countries on different continents).

A processor can comprise a microprocessor, a microcontroller, a processor module or subsystem, a programmable integrated circuit, a programmable gate array, or another control or computing device.

The storage media 106 can be implemented as one or more computer-readable or machine-readable storage media. Note that while in the example embodiment of FIG. 2 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs), digital video disks (DVDs), BluRays, or other optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that the computing system 100 is only one example of a computing system, and that the computing system 100 may have more or fewer components than shown, may combine additional components not depicted in the example embodiment of FIG. 2, and/or the computing system 100 may have a different configuration or arrangement of the components depicted in FIG. 2. For example, though not shown explicitly, the computing system 100 would generally include input and output devices such as a keyboard, a mouse, a display monitor, and a printer and/or plotter. The various components shown in FIG. 2 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs or other appropriate devices. These modules, combinations of these modules, and/or their combination with general hardware are all included within the scope of this disclosure.

Attention is now directed to processing procedures, methods, techniques, and workflows that are in accordance with some embodiments. Some operations in the processing procedures, methods, techniques, and workflows disclosed herein may be combined and/or the order of some operations may be changed.

In accordance with some embodiments, processing procedures, methods, techniques, and workflows are disclosed that include attenuating migration artifacts in eRTM images from VSP data.

A vertical seismic profile data for the subsurface geological formation may be obtained using conventional VSP acquisition methods (see, for example, R. Gilpatrick and D. Fouquet, A User's Guide to Conventional VSP Acquisition, Geophyscis: A Leading Edge of Exploration, March 1989, pp. 34-39).

In accordance with some embodiments, at least one local model dip estimation corresponding to a subsurface geological formation may be obtained externally or by calculation using a macro-earth model required for migration. The macro-earth model (velocities, density, etc.) for imaging can be obtained by tomography/inversion in surface seismic or VSP which may reveal earth model trends sufficiently to predict dip of interfaces. In these cases it is acceptable to use the direction of earth model gradients as dip normal. The following local model dip estimation formula can be used for normal vector n̅:

n̅^{grad}=∇̅V, (1)

where V is a scalar model parameter. It can be either one of velocities (V_{P}, V_{S}), density, or some scalar function of model parameters, e.g. impedance.

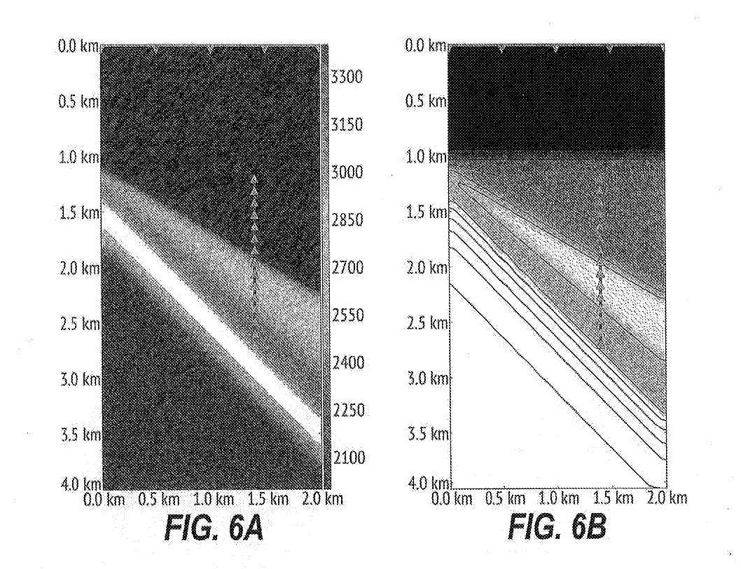

For example, in 2D case a dip normal vector can be converted to local model dip γ₀ using the formula:

$${γ}_{0} = {tan}^{- 1} \frac{{n}_{x}^{grad}}{{n}_{z}^{grad}} , \qquad ( 2 )$$

where nₓ^{grad} and n_{z}^{grad} are components of the normal vector n̅. As an illustration in the FIG. 6A the typical macro-earth velocity model is shown, while in the FIG. 6B one can see the local model dip estimate calculated according to the algorithm.

Now the attention is focused on determination of at least one dynamic dip estimation for at least one wavetype excited by sources and registered by receivers, this will be the definition of the term “dynamic dip estimation”. For this purpose, one may use vectors of waves directions such as the wave field phase velocity vectors, group velocity vectors, or energy flux (Poynting) vectors. For ease of discussion, we will refer to those vectors as Poynting vectors, though they are not limited to just energy flux. In at least one embodiment, they may be expressed as:

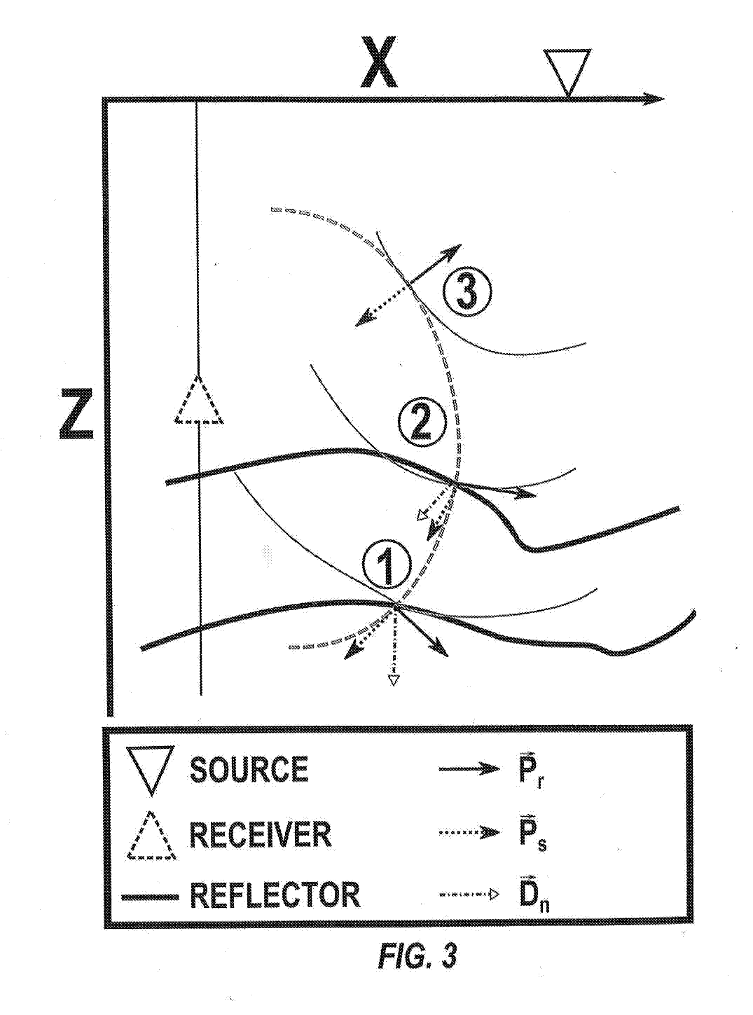

P̅ₛ=σₛ∂ₜūₛ, and P̅ᵣ=σᵣ∂ₜūᵣ, (3)

where σ denotes a stress tensor of the wavefield. These vectors correspond to group velocity vectors and they are normal to their respective wave fronts. In Reverse-time migration methods the fields ūₛ and σₛ are displacement and stress of the wavefield generated by the source, so the vector P̅ₛ corresponds to this propagation. The fields ū_{R} and σ_{R} are extrapolation of the wavefield that is registered by the receivers, so the vector P̅_{R} corresponds to the propagation direction from reflecting points to the receivers. In FIG. 3 at the detectable reflection point 1, the source and receiver Poynting vectors form a relatively small open angle, and their distribution is more closely consistent with the local model dip angle than the same vector distribution at the non-detectable reflection point 2. At point 3 in the overburden, P̅ₛ and P̅ᵣ point in opposite directions, producing a (relatively large) 180 degree open angle.

A further example of a directional information source is a motion constraint equation that uses an optical flow vector, and is normally expressed as:

$$∇ I v = \frac{\partial I}{\partial t} . \qquad ( 4 )$$

“I” represents the scalar wavefield function (e.g. an amplitude) and “v” represents a motion vector (optical flow vector). Thus, the scalar (i.e., dot) product of the gradient of I and v is equated to the negative of the partial derivative of I with respect to time, t.

The procedure of estimating dynamic dip γ depends on wavetypes excited by sources and registered by receivers (pressure or shear waves). For the non-converting reflection (pressure-pressure, shear-shear) the incident angle α should be equal to reflected angle β. In this cases the vector c can be estimated as a subtraction of vector P̅ᵣ from P̅ₛ and the dynamic dip can be calculated as rotation angle of the vector c. For the reflection with conversion (pressure to shear, shear to pressure) one may solve Snell's law in order to retrieve angles α and β. E.g. for P-S reflection the Snell's law can be written this way:

$$\frac{sin α}{{V}_{P}} = \frac{sin β}{{V}_{S}} . \qquad ( 5 )$$

After computation of angles α and β the vector c may be estimated using P̅ₛ and P̅ᵣ vectors:

$$c = \frac{{\overline{P}}_{s} cos β - {\overline{P}}_{r} cos α}{\vert {\overline{P}}_{s} cos β - {\overline{P}}_{r} cos α \vert} , \qquad ( 6 )$$

and the dynamic dip γ can be estimated as rotation angle of the vector c:

$$γ = {tan}^{- 1} \frac{{c}_{z}}{{c}_{x}} ,$$

where c_{z} and cₓ are components of the vector c.

Now the attention is focused on determining the at least one weighting coefficient based on the difference between the local model dip estimation and the dynamic dip estimation. The weighting coefficient W_{dip} is referred to herein as the “elastic model dip-guided filter”. The dip filter design can be analogous to the dip filter design used in VSP ray-based migration. According to some embodiments, the elastic model dip-guided reverse time migration imaging conditions weighting coefficient W_{dip} can be inversely proportional to δ:

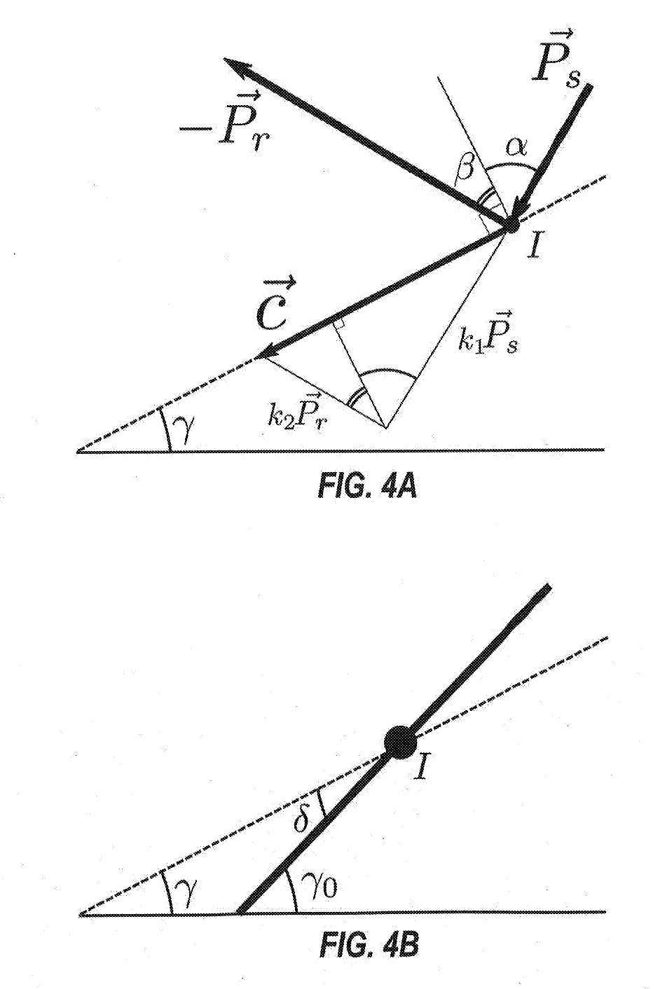

W_{dip}˜δ^{-k},

where δ is the calculated difference between a dynamic dip α estimated through source and receiver directionally-based vectors and a local model dip γ⁰ (see FIG. 4B):

δ=|γγ₀|,

and k>0 is some coefficient that regulates power of the filter. A motivation for using structural model dips stems from a difference between vertical seismic profile (VSP) and surface seismic profile (SSP) data imaging. In VSP processing, one usually has earth model representations available that are based on surface seismic image interpretation. The SSP interpretation can provide good estimates of structural dip. This local model dip information can be used to filter undesirable events during migration.

Now the attention is focused on determining a formulae for imaging elastic waves at reverse time migration conditions taking into account a dip angle of the geological formation. Conventionally, some formulaes for imaging elastic waves by reverse time migration method (eRTM conditions) may be expressed by:

I(x)=θₓ_{ₛ}∫ₓ_{ᵣ}∫₀^{t}^{ₘₐₓ}Dₛūₛ(x,t,xₛ)Dᵣūᵣ(x,t,xₛ,xᵣ)dtdxₛdxᵣ. (7)

That is, the eRTM default imaging condition cross-correlates source and receiver wave fields that are simulated by finite difference based wave equation propagation. The first factor under the integral, Dₛūₛ, represents the result of some differential operator Dₛ acting on source wavefield and the second factor, Dᵣūᵣ, represents the result of operator Dᵣ acting on the receiver wave field. The operators Dₛ and Dᵣ may be wavetype filtering operators, e.g. divergence and curl. The function notation indicates both wave fields are functions of space and time (“x” actually represents three space dimensions), and the subscripted “xₛ” and “xᵣ” indicate there are various sources and receivers being considered and over which the integrals are performed.

The above formula gives equal weighting to the product of source wave field ūₛ and receiver wave field ūᵣ at any image point, at any time step, for any source and receiver pair; and the formula does not consider the source and receiver wave field directions. The effect of those two aspects can be demonstrated by the simple survey setup of one source and one receiver, as shown in FIG. 3. A source is located as indicated by the downward pointing triangle on the x-axis, and a receiver is located as indicated by the upward pointing triangle slightly offset from the z-axis. The source wave field is represented by the three concave-up, downwardly progressing circular arcs and the receiver wave field is represented by the concave-left, semi-circular arc. Two reflectors are shown on the plot and three particular points (1, 2, and 3) are selected in the image domain.

At these three points vectors ūₛ and ūᵣ have significant amplitudes. Thus, their product will produce an image with comparable amplitude. However, only point 1 on the bottom reflector is detectable with this survey geometry. The other two are either non-detectable because of reflection angle limits (i.e., the reflected signal at point 2 propagates in a direction that cannot be detected by the receiver), or the point is not a true reflection point at all (i.e., point 3 is not on a reflector and thus comprises only transmitted signal).

To suppress the unwanted image artifacts, one may give appropriate weighting to the product of ûₛ and ūᵣ to retain the image amplitude at point 1 and attenuate the image amplitudes at points 2 and 3. To that end, one may use wavefield directional information related to the wavefield propagation.

In accordance with some embodiments, alternative eRTM imaging conditions, referred to herein as elastic model dip-guided eRTM imaging conditions, may be expressed, calculated, derived, and/or estimated by:

I(x)=∫ₓ_{ₛ}∫ₓ_{ᵣ}∫₀^{t}^{ₘₐₓ}W_{dip}(P̅ₛ,P̅ᵣ,Tₛ,Tᵣ)Dₛūₛ(x,t,xₛ)Dᵣūᵣ(x,t,xₛ,xᵣ)dtdxₛdxᵣ. (8)

To reiterate the above disclosure, the construction of W_{dip} in VSP applications uses the combination of: (1) direction of wave field propagation; (2) existing or performed estimates of local model dip information; and (3) geometrical considerations of detectable reflection events converted to the dynamic dip estimate. The elimination of artifacts is achieved using this weighting coefficient. The elastic model dip-guided filter may be created as one or more imaging conditions for use in applications for VSP data that correspond or relate to a subsurface three-dimensional geological formation.

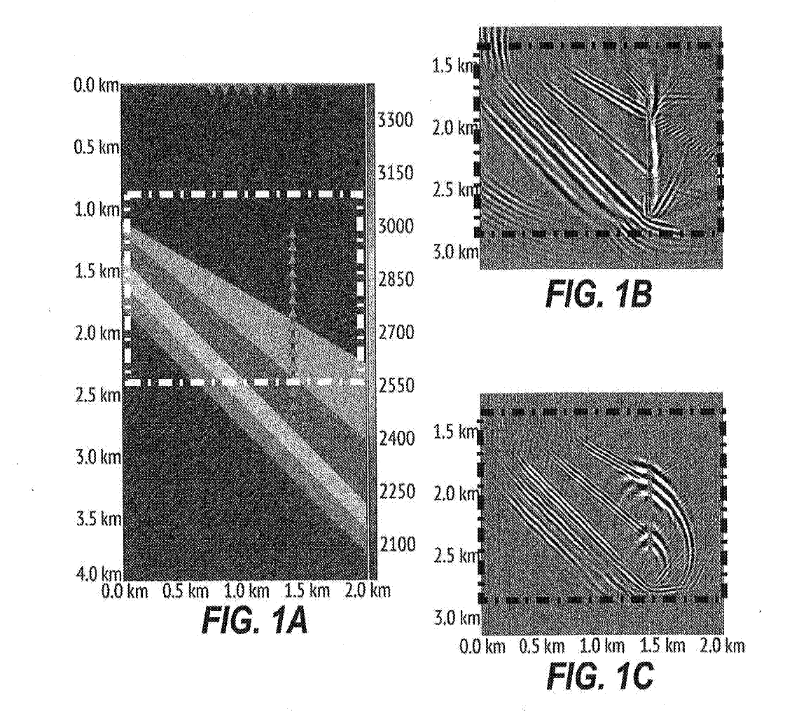

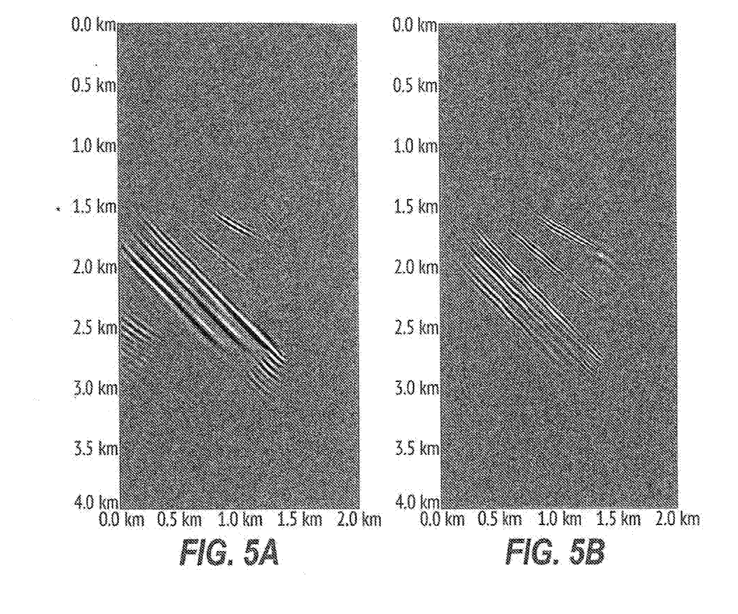

Attention is now directed to an example that compares an eRTM imaging condition embodiment disclosed herein with other eRTM techniques. The survey and model layout is shown in FIG. 1A. In FIG. 1B and FIG. 1C the result of ordinary eRTM algorithm is shown. The image results computed with the eRTM imaging condition embodied by Eq. (8) (shown in FIG. 5A, FIG. 5B) is clearly superior to the results computed from the conventional eRTM imaging condition of Eq. (7) (shown in FIG. 1B, FIG. 1C) based on the reduction or elimination of artifacts.

As stated or alluded to in the Background section above, for regions characterized by complex subsurface structures, eRTM is a powerful technique for accurately imaging the earth interior. However, eRTM suffers from artifacts and noise produced by the conventional zero-lag imaging condition (Eq. (7)). An example of a conventional eRTM image with artifacts was presented in FIG. 1B, FIG. 1C. Recall, the eRTM image was computed from synthetic data that correspond to the 2-D Vertical Seismic Profile (VSP) survey geometry shown in FIG. 1A. In FIG. 1B, FIG. 1C the polygons contain the area that could be illuminated by the VSP survey presented in FIG. 1A. Thus, all events outside of the polygon are considered artifacts. However, even inside the polygon, there are events that do not correspond to any spatial reflector features. To improve the quality of eRTM images, it is desirable to suppress those artifacts.

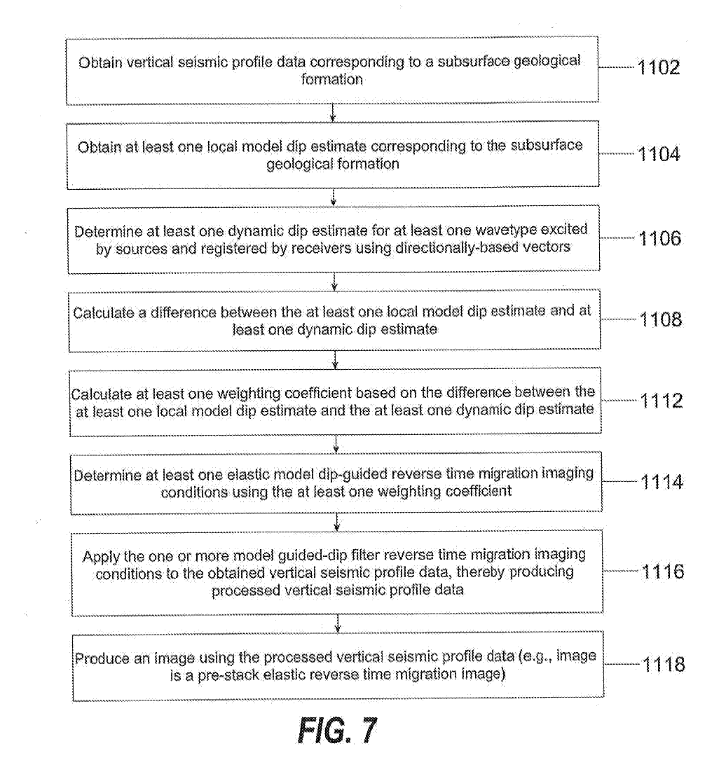

As shown in the flowchart of FIG. 7, to obtain a reverse time migrated elastic model dip-guided image, one may obtain vertical seismic profile data for the subsurface geological formation (1102) and one or local model dip estimates corresponding to the subsurface geological formation (1104). The dip estimates may be derived, for example, from surface seismic profile data. One or more dynamic dip estimate for at least one wavetype excited by sources and registered by receivers using directionally-based vectors are determined (1106) using, for example, wavefield directional information obtained from directionally-based vectors such as phase velocity vectors, group velocity vectors, or energy flux (Poynting) vectors. The one or more difference between the at least one local model dip estimate and at least one dynamic dip estimate are calculated (1108). At least one weighting coefficient based on the difference between the at least one local model dip estimate and the at least one dynamic dip estimate is calculated (1112). The one or more elastic model dip-guided reverse time migration imaging conditions are determined using at least one weigthing coefficient (1114). One or more model guided-dip filter reverse time migration imaging conditions are applied to the obtained vertical seismic profile data, thereby producing processed vertical seismic profile data to the obtained vertical seismic profile data (1116). An image may be produced using the processed vertical seismic profile data (1118). The image may be a elastic reverse time migration image.

While certain implementations have been disclosed in the context of seismic data collection and processing, those of ordinary skill in the art will recognize that the disclosed method can be applied in many fields and contexts where data involving structures arrayed in a three-dimensional space may be collected and processed, e.g., medical imaging techniques such as tomography, ultrasound, magnetic resonance imaging (MRI) and the like, sonar and laser imaging techniques and the like.

While only certain embodiments have been set forth, alternatives and modifications will be apparent from the above description to those skilled in the art. These and other alternatives are considered equivalents and within the scope of this disclosure and the appended claims.

1. A method for seismic imaging a geological formation, comprising:
recording data of vertical seismic profile in the geological formation;
performing at least one estimation of a geological formation model local dip;
performing at least one dynamic dip estimation for at least one wavetype excited by sources and registered by receivers using directionally-based vectors,
calculating a difference between the model local dip estimation and the dynamic dip estimation;
calculating at least one weighting coefficient based on the calculated difference between the model local dip estimation and the dynamic dip estimation;
using the calculated at least one weighting coefficient for determining at least one formulae for imaging with the use of elastic waves at reverse time migration conditions taking into account a dip angle of the geological formation,
applying the determined at least one formulae to the obtained vertical seismic profile data and producing at least one image of the geological formation.

2. The method of claim 1, wherein the at least one estimation of the geological formation model local dip is performed using surface seismic profile data.

3. The method of claim 1, wherein the directionally-based vectors are selected from the group consisting of phase velocity vectors, group velocity vectors, optical flow vectors, and energy flux (Poynting) vectors.

4. The method of claim 1 wherein the wavetypes excited by the sources and registered by the receivers comprise pressure and shear waves.

5. The method of claim 4 wherein the at least one dynamic dip estimation for pressure and shear waves reflected with conversion is determined using the Snell's law.

6. The method of claim 1, wherein the weighting coefficient is inversely proportional to the value of the difference between the model local dip estimation and the dynamic dip estimation.

7. The method of claim 1, wherein the directionally-based vectors are spatially smoothed.

8. A computing system for seismic imaging a geological formation comprising at least one processor, at least one memory, and at least one program stored in the at least one memory, wherein the programs comprise instructions, which when executed by the at least one processor, are configured to perform:
recording data of vertical seismic profile in the geological formation;
performing at least one estimation of a geological formation model local dip;
performing at least one dynamic dip estimation for at least one wavetype excited by sources and registered by receivers using directionally-based vectors,
calculating a difference between the model local dip estimation and the dynamic dip estimation;
calculating at least one weighting coefficient based on the calculated difference between the model local dip estimation and the dynamic dip estimation;
using the calculated at least one weighting coefficient for determining at least one formulae for imaging with the use of elastic waves at reverse time migration conditions taking into account a dip angle of the geological formation,
applying the determined at least one to the obtained vertical seismic profile data, thereby producing at least one image of the geological formation.
